(19) United States
(12) Patent Application Publication
(10) Pub. No.: US 2003/0055718 A1
(43) Pub. Date: Mar. 20, 2003

(54) Methods and systems for evaluating process production performance

(76) Inventors: Michael Orlando Cimini, Fairfield, OH (US); Lowell Wilson Bauer, Niskayuna, NY (US)

Correspondence Address: JOHN S. BEULICK, C/O ARMSTRONG TEASDALE LLP, ONE METROPOLITAN SQUARE, SUITE 2600, ST. LOUIS, MO, 63102-2740, US

(21) Appl. No.: 09/954,775

(22) Filed: Sep. 18, 2001

(51) Int. Cl. G06F 17/60

(52) U.S. Cl. 705/11

(57) ABSTRACT

A method for evaluating performance of a production process by users includes using a system including a server and at least one device connected to the server. The method includes determining evaluation area categories, receiving information relevant to the performance of the production process within the evaluation categories, compiling the received information, comparing the received information to reference information, and displaying the results to the user via the device.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to production processes, and more specifically to methods and systems for evaluating production performance.

As manufacturing demands have increased, there also has been an increased need for assessing production conditions to determine status and capabilities of elements contributing to the production process. Accurately assessing production processes facilitates more accurate planning and/or execution while preventing shortcomings that may lead to long-term process disruptions and/or manufacturing losses.

To facilitate more accurate production processes, at least some corporations employ outside consultants or process experts to evaluate shop processes and recommend improvements based on their knowledge and experience. However, employing such consultants may be expensive, time-consuming, and in some cases, may be politically unstable or deemed threatening to the internal workforce, and as a result, may actually hinder, rather than improve, the production process. Additionally, although such experts solicit suggestions from members within the production team, receiving suggestions of value may be a challenging problem. The problem becomes more pronounced when production needs, that may conflict with one another, are balanced against cost and time to market considerations. As such, accurately evaluating the capabilities and performance of a production process may be a time consuming and challenging task.

### BRIEF SUMMARY OF THE INVENTION

In one aspect, the present invention is a system for evaluating process capability. The system includes a device and a server. The server is connected the device and is configured to receive process capability information data from a user via the device. The server is further configured to compile the received information, display to the user information related to the production process, compare the received information to reference information, and display the results of the compared information to the user via the device.

In another aspect, a method for evaluating performance capability of a production process by users operating a system including a server and at least one device connected to the server is provided. The method includes determining evaluation area categories, receiving information relevant to the performance capabilities of the production process within the evaluation categories, compiling the received information, comparing the received information to reference information, and displaying the results to the user via the device.

In a further aspect, a method for evaluating the performance of a production process using a network connecting a plurality of users is provided. The network includes a server and a plurality of user display devices. The method includes soliciting from the users information concerning evaluation categories relevant to the production process, assigning each evaluation category at least one weighted factor, compiling the information received from the users with the server, evaluating the received information in comparison to reference information, and displaying the results to the users.

### BRIEF DESCRIPTION OF THE DRAWINGS

FIG. 1 is a system block diagram of a performance capability evaluation system;

FIG. 2 is an expanded version block diagram of an exemplary embodiment of a server architecture of a performance capability evaluation system;

FIG. 3 is a flowchart illustrating an exemplary embodiment of a method for evaluating part and process production performance capability;

FIG. 4 is an exemplary embodiment of a process capability evaluation questionnaire page used in executing the flowchart shown in FIG. 3; and

FIG. 5 is an exemplary embodiment of a summary screen used in executing the flowchart shown in FIG. 3.

### DETAILED DESCRIPTION OF THE INVENTION

Exemplary embodiments of systems and processes that facilitate evaluating production performance capability of a plurality of different parts and processes are described below in detail. The systems and processes facilitate, for example, evaluating a long term capability of a process to withstand user intervention. Furthermore, the systems and processes coach users, by suggesting means for improving the long term performance of a production process. The systems and processes are not limited to the specific embodiments described herein, but rather, components of each system and each process can be practiced independently and separately from other components and processes described herein. Each component and process can also be used in combination with other components and processes.

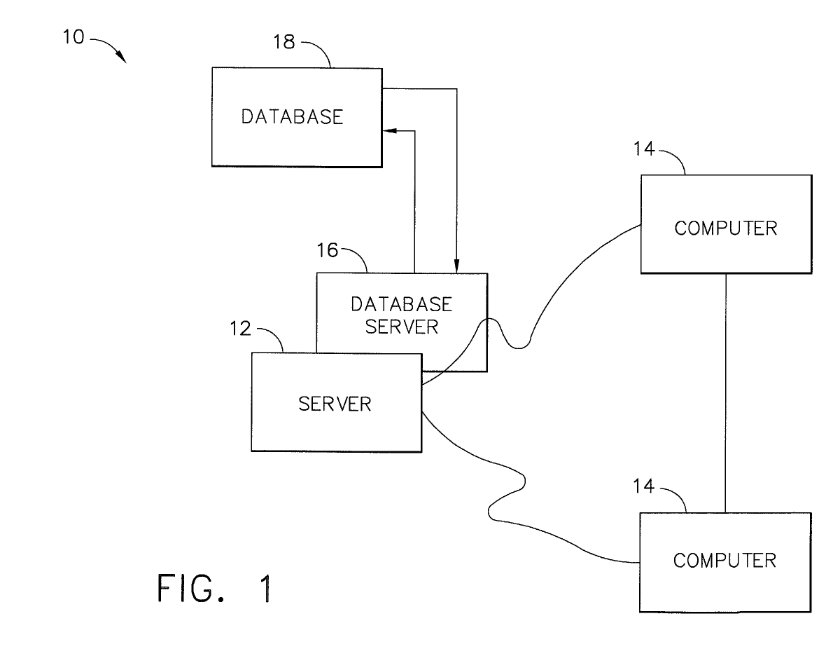

FIG. 1 is a system block diagram for a production performance evaluation system 10 used for evaluating the capability of a production process that performs a desired manufacturing function. In the exemplary embodiment, system 10 is a web-based system used for evaluating parts and process production performance capability. System 10 includes a server 12 and a plurality of devices 14 connected to server 12. In one embodiment, devices 14 are computers including a web browser, and server 12 is accessible to devices 14 via the Internet. In an alternative embodiment, devices 14 are servers for a network of customer devices. System 10 is coupled to a mass storage device (not shown). In the exemplary embodiment, server 12 includes a database server 16 coupled to a data storage device 20.

Devices 14 are interconnected to the Internet through many interfaces including through a network, such as a local area network (LAN) or a wide area network (WAN), through dial-in-connections, cable modems and special highspeed ISDN lines. Alternatively, devices 14 could be any device capable of interconnecting to the Internet including a web-based phone or other web-based connectable equipment. A database providing information relating to the plurality of plants and processes is stored on server 12 and can be accessed by users at one of devices 14 by logging onto server 12 through one of devices 14.

System 10 is configured to provide various user interfaces whereby users access operational data from equipment monitored at the plurality of plants. Server 12 accesses stored information and downloads the requested operational data to at least one of the client systems 14, when the request to download is received from client system 14. The databases are accessed by users using client system 14 configured with a standard web browser.

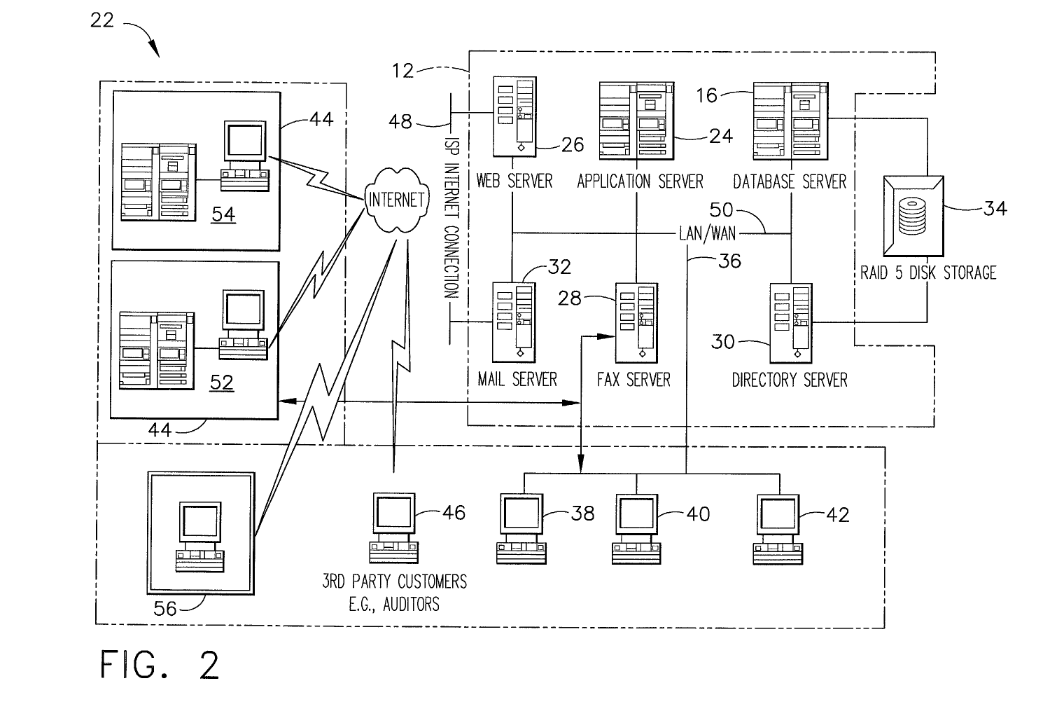

FIG. 2 is an expanded version block diagram of an exemplary embodiment of a server architecture of a performance evaluation system 22 for evaluating a capability of a production process to perform a desired manufacturing function In the exemplary embodiment, system 22 is a web-based supply chain used for evaluating parts and process production performance capability. Components of system 22, identical to components of system 10 (shown in FIG. 1), are identified in FIG. 2 using the same reference numerals as used in FIG. 1. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a computer having a web browser. Although the functions performed at the workstations typically are illustrated as being performed at respective workstations 38, 40, and 42, such functions can be performed at one of many computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Workstations 52 and 54 are personal computers having a web browser. Also, workstations 52 and 54 are configured to communicate with server sub-system 12. Furthermore, fax server 28 communicates with employees located outside the business entity and any of the remotely located user systems, including a user system 56 via a telephone link. Fax server 28 is configured to communicate with other workstations 38, 40, and 42 as well.

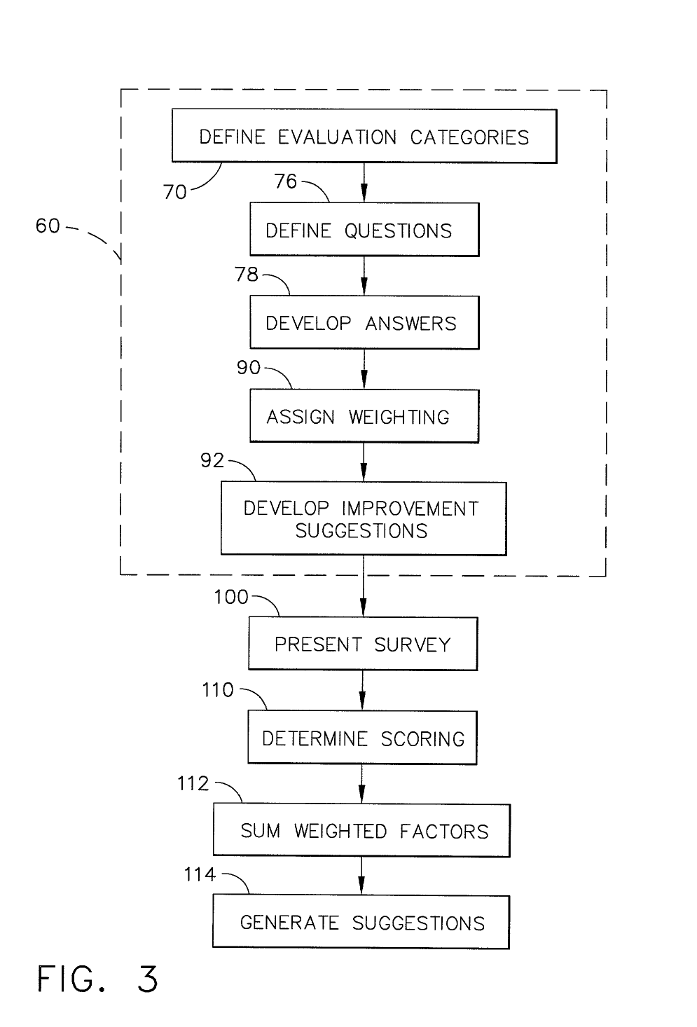

FIG. 3 is a flowchart illustrating one example embodiment of a method for evaluating the performance capability of a production process within a manufacturing facility that manufactures specific components using a performance evaluation system, such as system 10 (shown in FIG. 1) or system 22 (shown in FIG. 2). In the exemplary embodiment, the flowchart is executed using a web-based system. In another embodiment, the flowchart is executed using a stand-alone system. In a further embodiment, the evaluation is executed using written reports. The evaluation system focuses on process capabilities as applied to the production of specific components, and provides an implementation that is amenable for general process performance capability evaluation, rather than focusing on a quantitative impact on defect rates.

The evaluation system may be utilized by internal locations or any location that is relevant to the production process, including those of external entities such as suppliers or contractors. Initially, the evaluation system is designed 60. In the exemplary embodiment, the evaluation system is stored in a data storage device, such as device 34 (shown in FIG. 2). Because the evaluation system is stored in a database, the same implementation could be used with different data for different evaluations by simply connected with other databases. More specifically, during design 60 of the evaluation system, initially facility evaluation categories are selected or defined 70 based on an evaluation of the production performance capabilities of the process or part being evaluated. For example, in the exemplary embodiment, the evaluation system includes nine part/process evaluation categories, including complexity, conditions, control, error proofing, measurement, operator skill, planning, process, and shop practices.

The facility evaluation categories are selected to critical identify areas within the production process that are important to process performance, and may provide an opportunity for improvement, or may be a shortcoming, such as but not limited to, a time consuming activity, a historically expensive area, or an area that has experienced quality-control issues. The first of the nine exemplary categories is the complexity category which facilitates evaluating an extent to which a process avoids unique steps, parts or tools. Additionally, the complexity category is also impacted if the production process requires the intricate application of multiple disciplines during the completion.

The degree to which environmental factors affect the success of a process is represented within the conditions evaluation category. More specifically, such environmental factors include, but are not limited to, the temperature, humidity, light, electromagnetic noise, vibrational noise, dirt, debris, clutter, or working elevation.

The third facility evaluation category, the control evaluation category represents an amount of reduction of the tendency of a process to drift or shift from its initial setting over time. More specifically, the control evaluation category includes, but is not limited to, configuration control, scheduled routine maintenance, and/or calibration.

The error proofing evaluation category represents the degree of feedback to a process controller or operator received whenever anything within the process is not functioning as intended.

A degree of dependency on outside measurements for a successful completion of the process cycle is represented by the fifth facility evaluation category, the measurement evaluation category. More specifically, the measurement category includes, but is not limited to, measurement capability and system analysis.

The sixth facility evaluation category included in the exemplary embodiment is the operator skill evaluation category. This category represents an amount of ability required of an operator to understand, carryout, and predict the consequences of his/her interactions within the production process.

The planning skill evaluation category represents the adequacy of a set of instructions that detail the required materials and a sequence of how the production process is to be performed. This category is similar to the process evaluation category which represents the presence of a scope of work description containing a sequence of steps including a set of unique parameters which differentiate one operation from other operations.

The shop practices evaluation category is the ninth facility category included in the exemplary embodiment, and represents a degree to which favorable conditions exist within the process due to the culture of the shop and the past accepted expectations.

After the facility evaluation categories are defined 70, questions are designed 76 to probe and determine performance each facility evaluation category. More specifically, the evaluation system employs a survey format that includes questions and multiple-choice answers. The system also maintains a record of which category is impacted by which questions. Accordingly, after the questions are designed 76, a series of multiple-choice answers are developed 78. More specifically, the multiple-choice answers are developed 78 to encompass an expected range of answers from users responding to the survey questions. In one embodiment, the questions and answers are stored in a database that is implemented as a spreadsheet that includes data stored in tables.

Because it is possible that a question may apply to more than one evaluation area, a performance weight factor is then assigned 90 to each multiple-choice answer in each relevant evaluation category. The weight factors normalize the data received and compiled from the different survey categories. More specifically, in the exemplary embodiment, desired answers are assigned weight factors that, as described in more detail below, are associated with suggestions for each answer that are relevant to process capability improvement. Accordingly, after each weight factor is assigned 90, improvement suggestions for each question and category are developed 92 and linked to each question.

After the improvement suggestions and weighted answers are linked, the design 60 of the evaluation system is complete. The questions are then presented 100 to the user in a survey format including multiple-choice answers. Upon answering the survey questions, a numerical score is determined 110 for each evaluation category. The numerical score represents a relative capability of the process being evaluated to perform a desired manufacturing function. In the exemplary embodiment, an evaluation engine stored in the server scores the answers to determine 110 an ability of the process to perform its designated function successfully over time. More specifically, weighted factors assigned to the answers in various evaluation criteria are summed 112. The summed weighted factors are compared to a reference process that represents an ideal production process.

Suggestions are then generated 114 for possible process improvements to the production process. The suggestions generated 114 are a list of recommendations of specific actions to improve long term process performance in each of the evaluation areas. More specifically, the suggestions are generated 114 based on the answers provided to the questions. Accordingly, the weighted factors enable the suggestions to be presented in a priority order based on the weights assigned to the possible answers. Because the numeric values are normalized with the weighted factors, the numeric values also provide a basis for comparisons between different production processes. As a result, a long term capability of a process to withstand human and environmental intervention may be evaluated.

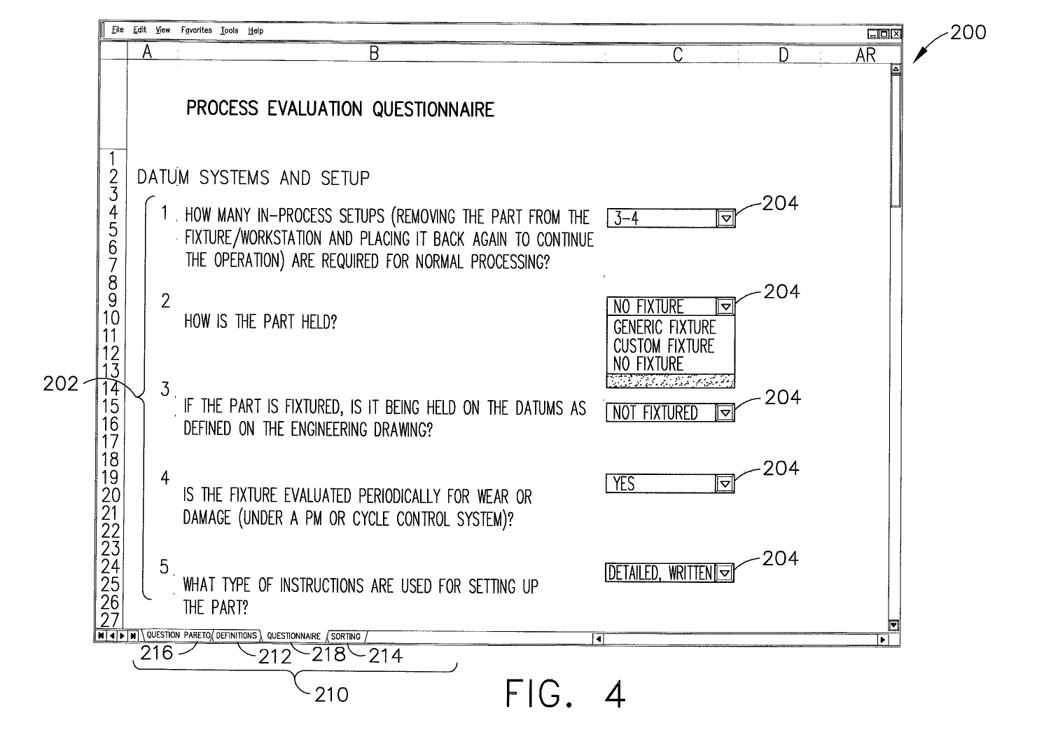

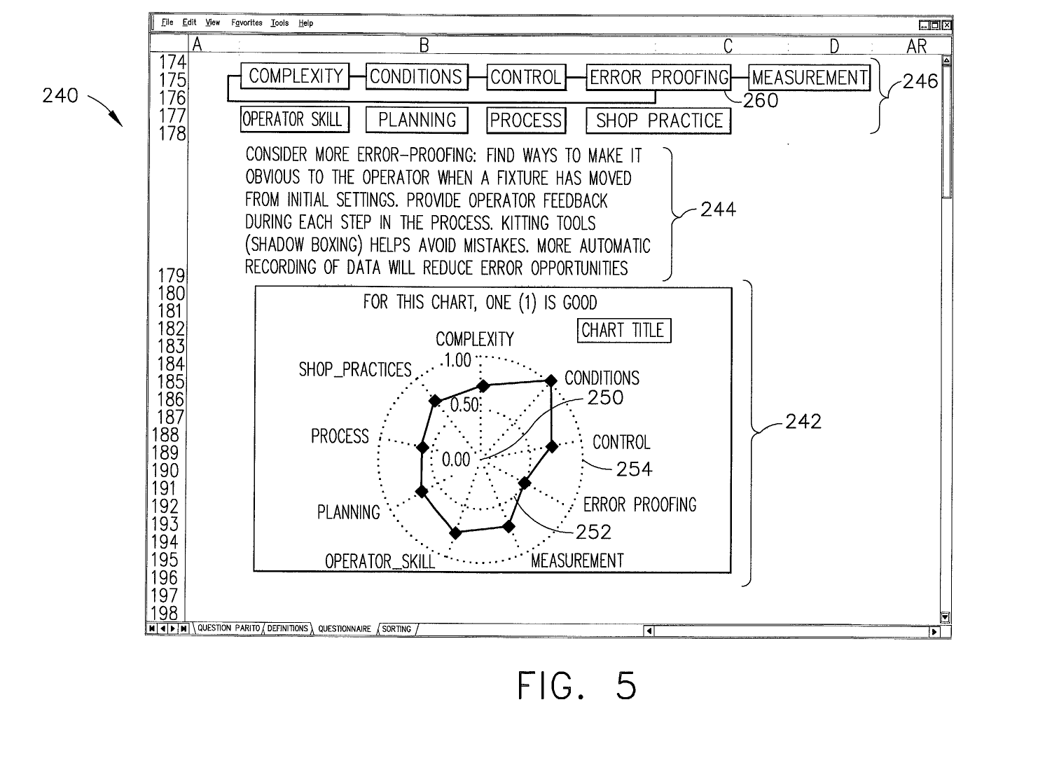

FIGS. 4 and 5 illustrate example web-pages for the above-described web-based performance evaluation system. The web-pages shown in FIGS. 4 and 5 are examples only and there are a plurality of variations possible. For example, in an alternative embodiment, the evaluation system is executed through a series of spreadsheets. Through a series of user interfaces, a user is provided various questions and answers used to evaluate a performance of the production process. FIGS. 4 and 5 illustrate the type of the information accumulated, stored and updated to support the performance evaluation system.

The information contained in these user interfaces, i.e., web-pages, is exemplary only and may change from one performance evaluation system to another. The information provided through the user interfaces depicted in FIGS. 4 and 5 is stored in a centralized database within centralized database 18 (shown in FIG. 1) and retrieved by server system 12 (shown in FIG. 1) as required, and as described above. Many variations of particular user interfaces viewable by the customer may be utilized. The following description refers to one set of web-pages that can be used to prompt the user to retrieve a variety of performance questions used to provide recommendations for improving the production process. Of course, many variations of such web-pages are possible.

FIG. 4 is an exemplary embodiment of a process evaluation questionnaire page 200 that may be used in executing the flowchart shown in FIG. 3. In one embodiment, web page 200 is accessible after executing a security login. Web page 200 includes a plurality of questions 202 that are used to determine performance capability and to identify shortfalls within each facility evaluation category. Each question 202 includes a grouping of associated possible multiple choice answers 204 presented in pull-down menus. In an alternative embodiment, possible answers 204 are presented in radio buttons. For example, in FIG. 4, for the second question, which asks how a part is held during processing, three answers are illustrated as being available for selection. The answers are weighted, as described above. In the one embodiment, the answers are weighted between zero and one, such that answers with smaller weights, such as those weighted with a zero, are more favorable. In an alternative embodiment, answers with larger weights, such as those weighted with a one, are more favorable.

Additionally, web page 200 includes a plurality of tabs 210 which enable a user to view additional information. More specifically, tabs 210 include a definitions tab 212, a sorting tab 214, a question pareto tab 216, and a tab 218 representing the questionnaire. Definitions tab 212 enables a user to view definitions of evaluation categories. Sorting tab 214 enables a user to view recommended suggestions for each evaluation category after the questions have been answered. Question pareto tab 216 enables a user to evaluate which questions affect which process evaluation categories. More specifically, tab 216 displays information that is useful when new survey questions are designed 76 (shown in FIG. 3). Accordingly, the information displayed through tab 216 provides the user with the flexibility to easily change the survey emphasis as the needs and criteria within the business change.

FIG. 5 is an exemplary embodiment of a summary screen 240 used in executing the flowchart shown in FIG. 3. More specifically, summary screen 240 provides a visual representation of the weighted numerical scores of each evaluation category based on the responses selected by the user for each question. The numerical scores represent a relative capability of the process being evaluated to perform a desired manufacturing function. In the exemplary embodiment, web page 240 includes a graphical representation portion 242, a recommendations text area 244, and a plurality of hyperlink selection buttons 246. Graphical portion 242 visually indicates the scores of each evaluation category and is known as a radar plot. More specifically, the scores extend circumferentially around a center point 250 that represents a score of zero. A first ring 252 surrounding point 252 represents a score of 0.50, and a second outer ring 254 represents a score of 1.00, which on this graph is the best score obtainable.

As can be seen in the exemplary graphical portion 242, the evaluation category conditions received the highest score, and the evaluation category error proofing received the lowest score, and thus, provides an opportunity for the most improvement relative to the other evaluation categories scored. More specifically, buttons 246 are selectable for a user to view generated suggestions for possible process improvements within each specific evaluation category of the production process. For example, in FIG. 5, a button 260 representing the error proofing evaluation category has been depressed. Depressing button 260 displays production process improvement suggestions within text area 244. Depressing other buttons 246 will cause other improvement suggestions unique to each evaluation category suggested to be displayed within text area 244.

The above-described performance evaluation system is cost-effective and highly reliable. The performance capability evaluation system employs a survey format including questions and multiple-choice answers. Upon answering the survey questions, the process being evaluated receives a numerical score in each of a number of pre-defined evaluation categories. The numerical score represents the relative capability of the production process to perform its desired manufacturing function. The evaluation system also suggests areas for possible process improvements and provides a basis for comparisons between different processes. In addition, the evaluation system provides recommendations for specific actions to improve process performance in each of the pre-defined evaluation areas based on the answers selected for the questions.

While the invention has been described in terms of various specific embodiments, those skilled in the art will recognize that the invention can be practiced with modification within the spirit and scope of the claims.

What is claimed is:

1. A system for evaluating process performance, said system comprising:
a device; and
a server connected to said device and configured to receive process production capability information data from a user via said device, said server further configured to:
compile the received information;
display to the user information related to the production process;
compare the received information to reference information; and
display the results of the compared information to the user via said device.

2. A system in accordance with claim 1 wherein said server further configured to receive information pertaining to process performance evaluation categories selected by the user.

3. A system in accordance with claim 2 wherein said server further configured to receive information regarding at least one of a planning, shop practices, and operator skill.

4. A system in accordance with claim 2 wherein said server further configured to receive information regarding at least one of a complexity, conditions, control, error proofing, measurement, and process.

5. A system in accordance with claim 1 wherein said server further configured to receive information including a numerical score that expresses a relative capability of a process to perform a desired manufacturing function.

6. A system in accordance with claim 5 wherein said server further configured to:
assign received information a weighted value:
sum received information weights;
evaluate weighted summed data; and
display results in a ranked order based on weighted data.

7. A system in accordance with claim 1 wherein said device configured to be a server for a network of customer devices.

8. A system in accordance with claim 1 wherein said server and said device are connected via a network.

9. A method for evaluating performance capabilities of a production process by operating a system including a server and at least one device connected to the server, said method comprising:
determining evaluation area categories;
receiving information relevant to the capabilities of the production process within the evaluation categories;
compiling the received information;
comparing the received information to reference information; and
displaying the results to the user via the device.

10. A method in accordance with claim 9 further comprising assigning a weight factor to information received within each evaluation category.

11. A method in accordance with claim 10 wherein comparing the received information further comprises determining a relative capability of the production process to perform a desired manufacturing function.

12. A method in accordance with claim 10 wherein displaying the results further comprises numerically ranking the production process evaluation areas based on the results.

13. A method in accordance with claim 10 wherein displaying the results further comprises displaying the results in a format that facilitates comparisons between a plurality of production process evaluation areas.

14. A method in accordance with claim 10 wherein determining evaluation area categories further comprises selecting at least one evaluation area category that represents at least one of production complexity, conditions, control, error proofing, measurement, operator skill, planning, process, and shop practices.

15. A method for evaluating performance of a production process using a network connecting a plurality of users, the network including a server and a plurality of user display devices, said method comprising:
soliciting from the users information concerning evaluation categories relevant to the production process;
assigning each evaluation category at least one weighted factor;
compiling the information received from the users with the server;
evaluating the received information in comparison to reference information; and
displaying the results to the users.

16. A method in accordance with claim 15 wherein at least one user is physically remote from another user, displaying the results further comprises displaying the results in a format that facilitates comparisons between the evaluation areas.

17. A method in accordance with claim 16 wherein soliciting from the users information further comprises soliciting information relevant to at least one of production complexity, production conditions, control, error proofing, measurement, operator skill, planning, process, and shop practices.

18. A method in accordance with claim 17 wherein soliciting from the users information concerning evaluation categories further comprises soliciting information from the users via at least one of a survey, radio push-buttons, and pulldown menu.

19. A method in accordance with claim 16 wherein evaluating the received information in comparison to reference information comprises determining a relative capability of the production process to perform a desired manufacturing function.

20. A method in accordance with claim 16 wherein displaying the results further comprises numerically ranking the production process evaluation areas based on the results.
